(19) United States
(12) Patent Application Publication
(10) Pub. No.: US 2026/0103927 A1
(43) Pub. Date: Apr. 16, 2026

(54) Hinge Fastener

(71) Applicant: Illinois Tool Works Inc., Glenview, IL (US)

(72) Inventor: Joel R. Lee, Peotone, IL (US)

(21) Appl. No.: 19/346,792

(22) Filed: Oct. 1, 2025

Related U.S. Application Data
(60) Provisional application No. 63/707,263, filed on Oct. 15, 2024.

(51) Int. Cl. E05D 3/02; E05D 5/12

(52) U.S. Cl. CPC E05D 3/02; E05D 5/125

(57) ABSTRACT

A hinge clip assembly is provided for coupling a lid to a container having a hinge pin. The assembly includes a first body, a second body, and a hinge pivotally connecting the bodies for movement between a shipment position and an installed position. In the installed position, at least a portion of the lid is sandwiched between the first body and the second body. The hinge defines a pin receiver configured to engage the hinge pin of the container, thereby permitting rotation of the lid relative to the container. Various embodiments include a living hinge integrally formed with the first and second bodies, snaps that secure the assembly to through-holes in the lid, and stops that limit rotation of the lid in a closed position. The assembly may further include recessed or complementary lid regions that stabilize the hinge connection and reduce lateral movement.

### RELATED APPLICATION

The present application claims priority to United States Provisional Patent Application No. 63/707,263, filed October 15, 2024, and entitled “Hinge Fastener,” which is hereby incorporated by reference in its entirety.

### BACKGROUND

Vehicle manufacturers continually seek to maximize cargo storage capacity. A common approach is to integrate dedicated storage compartments within the vehicle, such as in a truck bed, beneath the floor, or in other designated areas. In such configurations, certain vehicle components are designed to function as removable or movable covers, thereby serving as lids that conceal and protect the underlying cargo space.

In some existing designs, the lid is hingedly attached to the vehicle body (or an associated accessory), allowing it to pivot open and expose the storage compartment. However, these systems often require tools and fasteners, such as screws or rivets, for installation. This not only makes the assembly process time-consuming and labor-intensive but also restricts disassembly. Once installed, the lid is typically not intended for easy removal or reattachment, which complicates access to the storage compartment, routine maintenance, and/or repair activities.

Accordingly, there is a need for a storage system that incorporates a fastening assembly capable of being assembled, opened, and closed without the use of tools or additional fasteners. Moreover, such a system should allow for repeated assembly and disassembly, thereby improving convenience, serviceability, and overall functionality.

The present disclosure relates generally to a hinge clip assembly, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1a illustrates a storage system having a lid coupled to a container via a hinge clip assembly, shown in a closed position, in accordance with an aspect of the present disclosure.

FIG. 1b illustrates the storage system of FIG. 1a in an open position.

FIG. 1c illustrates the hinge clip assembly and a portion of the lid in a pre-assembly position.

FIGS. 2a through 2c illustrate the hinge clip assembly during different stages of assembly with the lid.

FIG. 3a illustrates a first perspective view of the hinge clip assembly in a shipped position.

FIG. 3b illustrates a second perspective view of the hinge clip assembly in the shipped position.

FIG. 3c illustrates a first side elevation view (e.g., a rear view) of the hinge clip assembly in the shipped position.

FIG. 3d illustrates a second side elevation view (e.g., a front view) of the hinge clip assembly in the shipped position.

FIG. 3e illustrates a third side elevation view of the hinge clip assembly in the shipped position.

FIG. 3f illustrates a fourth side elevation view of the hinge clip assembly in the shipped position.

FIG. 3g illustrates a bottom plan view of the hinge clip assembly in the shipped position.

FIG. 3h illustrates a top plan view of the hinge clip assembly in the shipped position.

FIG. 4a illustrates a first side elevation view (e.g., a rear view) of the hinge clip assembly in an installed position.

FIG. 4b illustrates a second side elevation view (e.g., a front view) of the hinge clip assembly in the installed position.

FIG. 4c illustrates a third side elevation view of the hinge clip assembly in the installed position.

FIG. 4d illustrates a fourth side elevation view of the hinge clip assembly in the installed position.

FIG. 4e illustrates a top plan view of the hinge clip assembly in the installed position.

FIG. 4f illustrates a bottom plan view of the hinge clip assembly in the installed position.

FIG. 4g illustrates a perspective view of the hinge clip assembly in the installed position.

FIG. 4h illustrates a cross-sectional perspective view of the hinge clip assembly in the installed position, taken along cut line A-A of FIG. 4e.

FIG. 4i illustrates a cross-sectional perspective view of the hinge clip assembly in the installed position, taken along cut line B-B of FIG. 4e.

FIG. 4j illustrates a cross-sectional perspective view of the hinge clip assembly in the installed position, taken along cut line C-C of FIG. 4e.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

In one example, a hinge clip assembly for coupling a lid to a container having a pin comprises: a first body; a second body; and a hinge coupling the first body to the second body, the first body and the second body being pivotable relative to one another between a shipment position and an installed position, wherein, in the installed position, at least a portion of the lid is sandwiched between the first body and the second body, and wherein the hinge defines a pin receiver configured to pivotally secure with the pin of the container to permit rotation of the lid relative to the container.

In another example, a hinge clip assembly for coupling a lid to a container having a pin comprises: a first body and a second body; a living hinge integrally formed with the first body and the second body, the living hinge including a flat spacer sized to correspond to a thickness of a hinge region of the lid and at least one flexible area disposed adjacent the flat spacer; and a plurality of snaps configured to couple the first body to the second body, wherein, in an installed position, at least a portion of the lid is sandwiched between the first body and the second body, the plurality of snaps extend through corresponding through-holes in the lid, and the living hinge defines a pin receiver configured to pivotally secure with the pin of the container to permit rotation of the lid relative to the container.

In some examples, the hinge comprises a hinge clip defining the pin receiver.

In some examples, the hinge clip comprises a stop configured to engage the container and thereby limit movement of the lid to a closed position.

In some examples, the hinge comprises a living hinge integrally formed with the first body and the second body.

In some examples, the living hinge includes a flat spacer sized to correspond to the thickness of the lid at a hinge region, and at least one flexible area disposed adjacent the flat spacer.

In some examples, the hinge clip assembly further comprises a plurality of snaps configured to couple the first body to the second body.

In some examples, at least one snap of the first body is configured to engage with a complementary snap of the second body to collectively define a generally circular cross-section.

In some examples, each snap is generally D-shaped in cross-section to facilitate insertion through a corresponding through-hole in the lid.

In some examples, a hinge region of the lid comprises a plurality of through-holes through which the snaps extend to secure the hinge clip assembly to the lid.

In some examples, the hinge region of the lid is recessed and shaped to complement the first body and/or the second body, thereby mitigating lateral movement of the hinge clip assembly relative to the lid.

In some examples, the hinge clip assembly is fabricated from a thermoplastic material.

In some examples, the hinge clip assembly is fabricated from a thermoplastic elastomer (TPE).

In some examples, the hinge clip assembly comprises a composite material.

In some examples, the hinge permits rotation of the lid about an axis defined by the pin, the lid being movable between an open position and a closed position relative to the container.

In some examples, the lid includes a handle, the hinge clip assembly and the pin collectively support hinged movement of the lid.

In some examples, the hinge clip assembly is a unitary component.

In some examples, at least one snap of the first body engages with a complementary snap of the second body to collectively define a generally circular cross-section.

In some examples, each snap is generally D-shaped in cross-section and includes a chamfered leading edge to facilitate insertion through the corresponding through-hole in the lid.

In some examples, the hinge region of the lid is recessed and shaped to complement the first body and/or the second body, and further comprises alignment ribs configured to engage grooves in the hinge clip assembly to mitigate lateral movement of the hinge clip assembly relative to the lid.

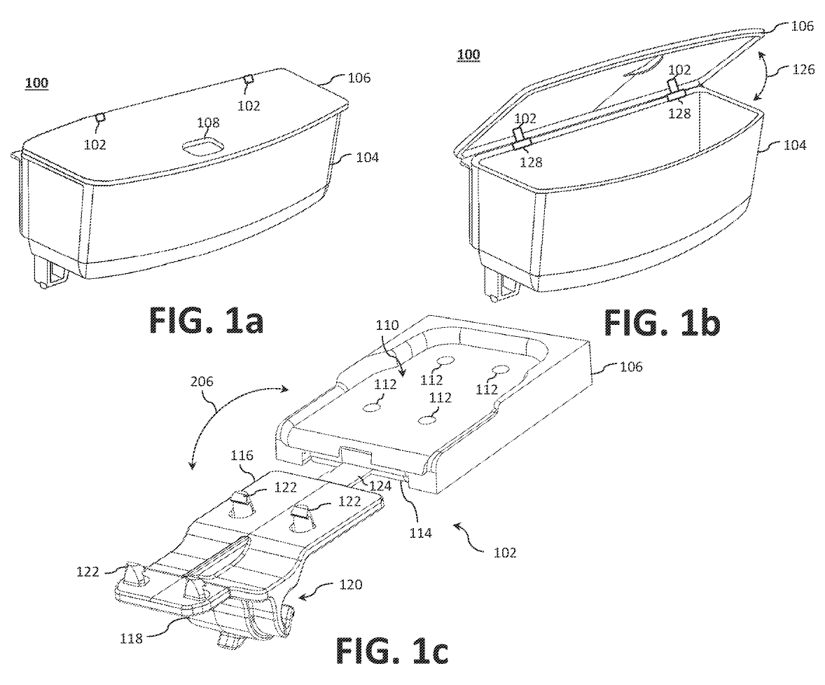

FIGS. 1a through 1c illustrate a hinge clip assembly 102 for use in a system, such as a storage system 100, according to an embodiment of the present disclosure. In particular, FIG. 1a illustrates the storage system 100 including a container 104 and a lid 106, the lid 106 being coupled to the container 104 via the hinge clip assembly 102 coupled to the lid 106 and a hinge pin 128 associated with the container 104. In FIG. 1a, the storage system 100 is shown in a closed position in which the lid 106 overlies the container 104. FIG. 1b illustrates the storage system 100 of FIG. 1a in an open position, with the lid 106 pivoted away from the container 104 to allow access to an interior volume defined by the container 104. FIG. 1c illustrates the hinge clip assembly 102 and a portion of the lid 106 in a pre-assembly position, prior to installation.

The storage system 100 may be configured for use in a vehicle. More specifically, the hinge clip assembly 102 may be employed with a cargo storage system for use in a trunk, frunk, floor compartment, pickup bed, or other storage area of a vehicle. While illustrated as a truck bed storage system, other applications for the hinge clip assembly 102 are contemplated where a pivoting lid is desired. In one embodiment, the container 104 defines a recessed cavity for receiving tools, personal items, or emergency equipment, and the lid 106 selectively covers the cavity. The lid 106 may include an integrated handle 108 to facilitate lifting, and the lid 106 is hingedly coupled to the container 104 via the hinge clip assembly 102 and a hinge pin 128, as further described below.

The pin 128 may be embodied as a cylindrical rod, post, or dowel coupled to one or more walls of the container 104, thereby defining a pivot axis about which the lid 106 rotates (see arrow 126, FIG. 1a). The hinge clip assembly 102 is configured to couple pivotally to the pin 128 by way of a hinge clip 118 that defines a pin receiver 120. The pin receiver 120 may be generally cylindrical and dimensioned to snap onto, press-fit, or otherwise receive the pin 128. As illustrated, the pin receiver 120 may be discontinuous (e.g., C-shaped or horseshoe-shaped) to allow deflection during engagement with the pin 128, thereby providing a snap-fit retention. The hinge clip 118 may further comprise an external stop 204, which can be formed as a protrusion, rib, or boss. The stop 204 is positioned to abut a corresponding wall or feature of the container 104 when the lid 106 is rotated to the closed position, thereby restricting further rotation and securing the lid 106 against over-travel and/or securing the lid 106 in a closed position.

Depending on the application, one or both of the lid 106 and/or the container 104 may be fabricated from, for example, synthetic or semi-synthetic polymers (e.g., plastics, such as acrylonitrile butadiene styrene (ABS) and polyvinyl chloride (PVC), etc.), composite materials (e.g., fiber glass), metal (or a metal alloy), or a combination thereof.

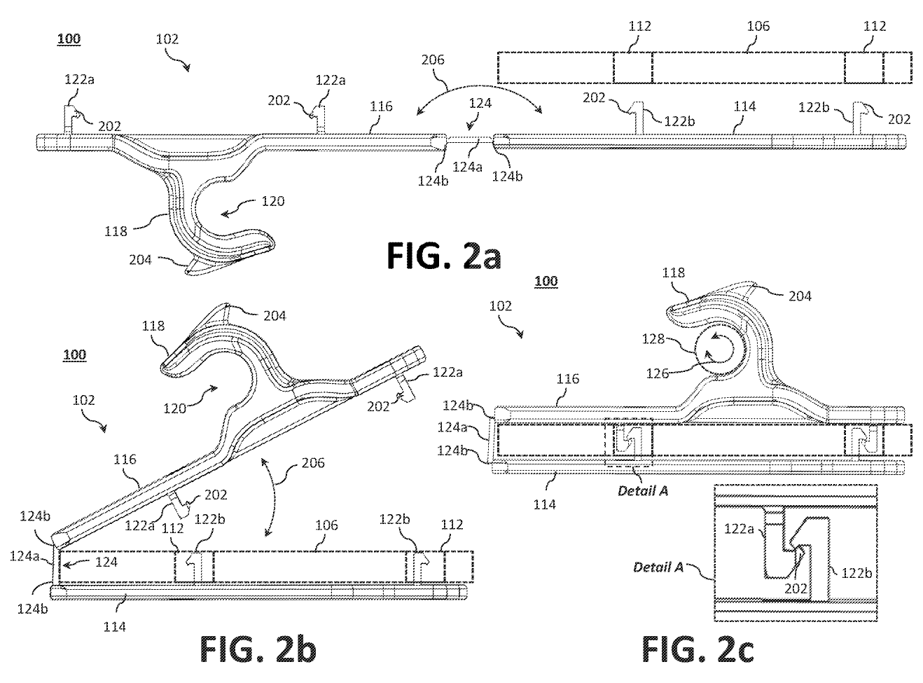

FIGS. 2a through 2c illustrate the hinge clip assembly 102 during progressive stages of assembly with the lid 106. FIG. 2a illustrates the hinge clip assembly 102 in a shipment position, wherein the hinge clip assembly 102 are unassembled or generally flat position for transport. FIG. 2b illustrates the hinge clip assembly 102 in a partially assembled position (e.g., pivoting from the flat position). FIG. 2c illustrates the hinge clip assembly 102 in a fully installed position, with the hinge clip assembly 102 fully pivoted such that a hinge region 110 of the lid 106 is sandwiched between a first body 114 and a second body 116 of the hinge clip assembly 102.

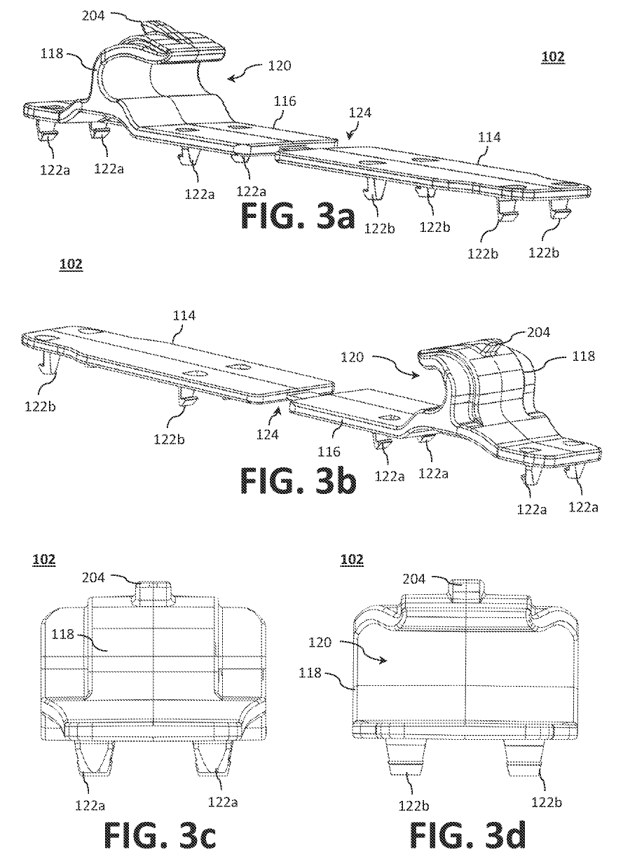

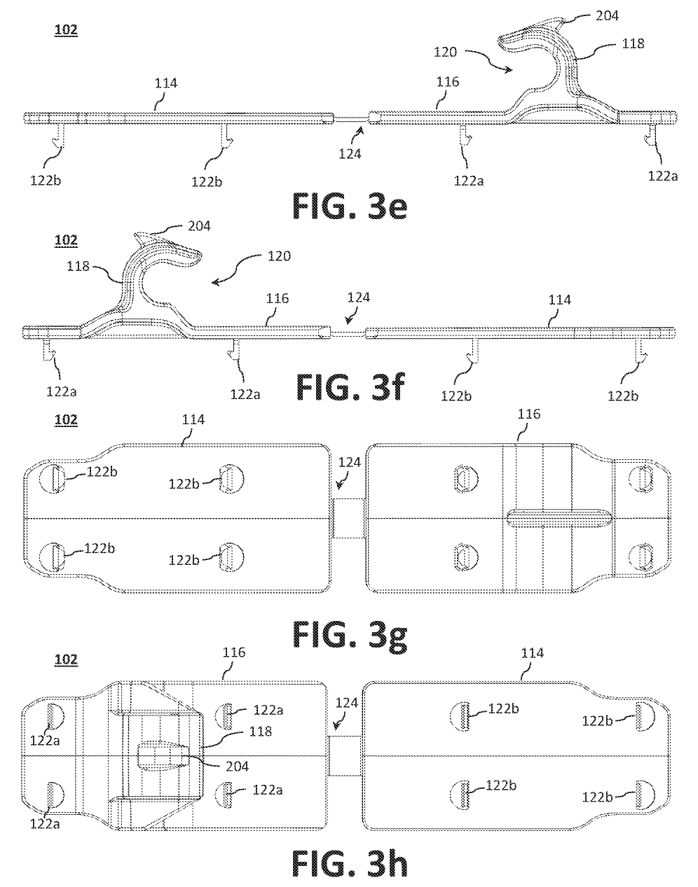

FIGS. 3a through 3h illustrate various views of the hinge clip assembly 102 in the shipment (or pre-installed) position. Specifically, FIG. 3a illustrates a first perspective view, FIG. 3b a second perspective view, FIGS. 3c through 3f illustrate side elevation views (rear, front, left, right), and FIGS. 3g and 3h illustrate bottom and top plan views, respectively. Collectively, these figures depict the structural details of the hinge clip assembly 102 prior to engagement with the lid 106.

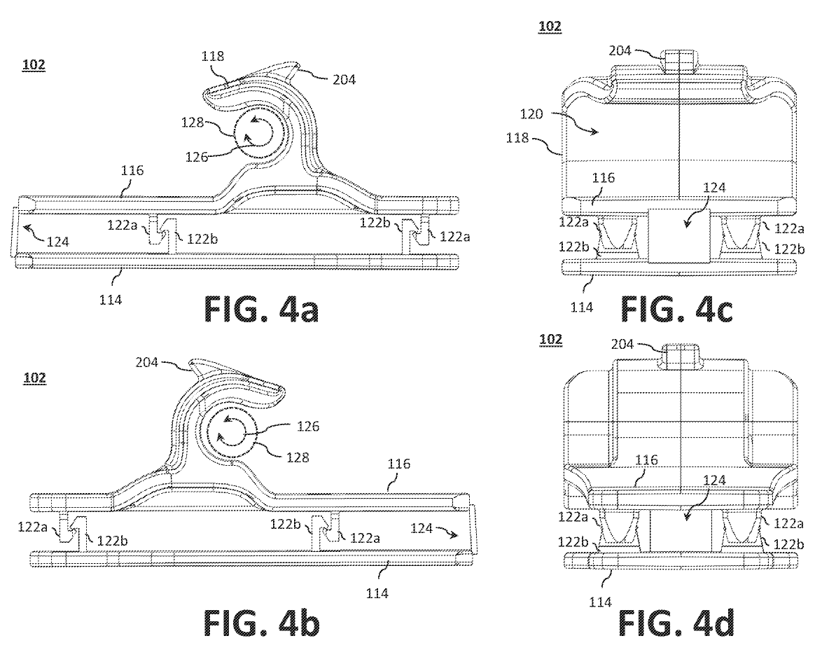

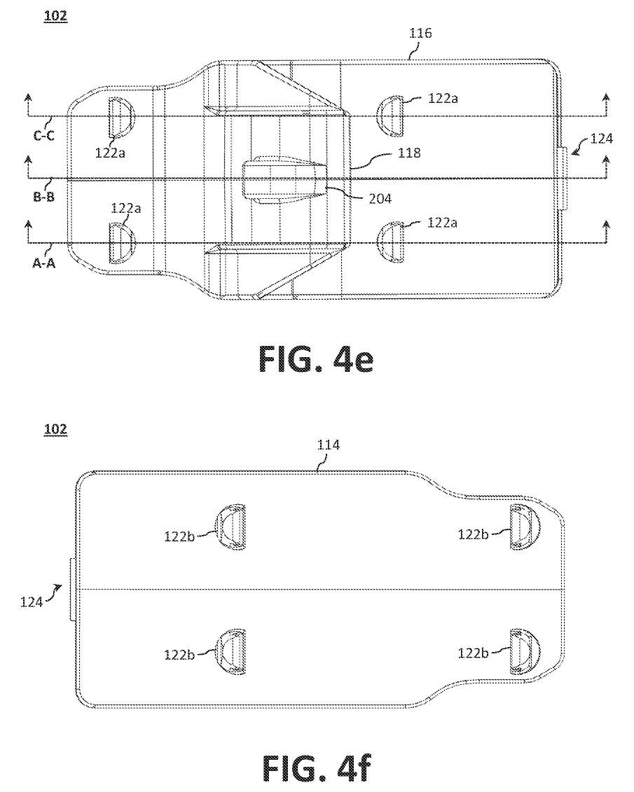

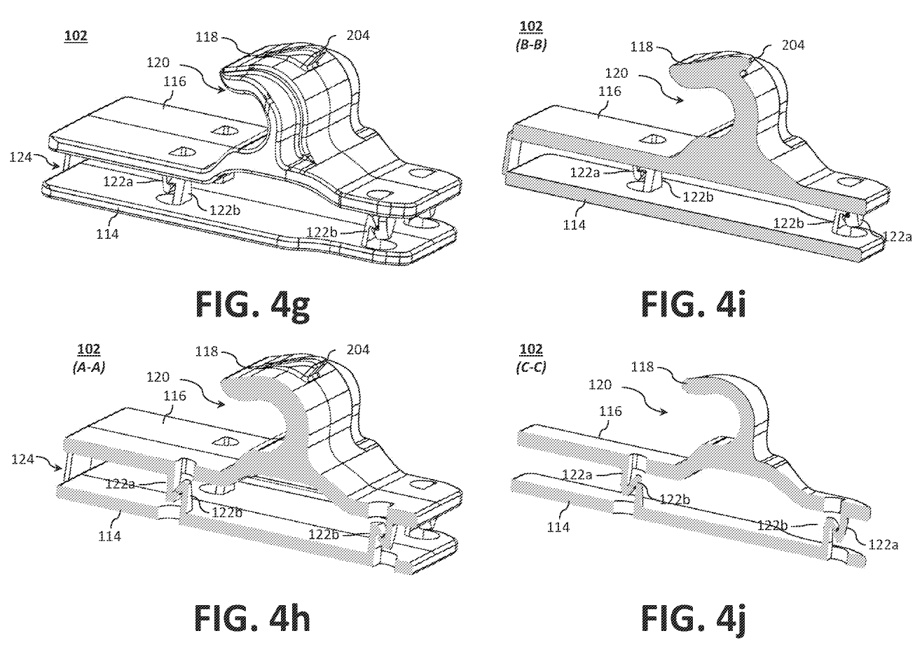

FIGS. 4a through 4j illustrate the hinge clip assembly 102 in the installed position. FIG. 4a shows a first side elevation view (rear), FIG. 4b a second side elevation view (front), FIGS. 4c and 4d additional side elevation views, and FIGS. 4e and 4f top and bottom plan views. FIG. 4g illustrates a perspective view of the installed hinge clip assembly 102. FIGS. 4h, 4i, and 4j illustrate cross-sectional perspective views taken along cut lines A-A, B-B, and C-C of FIG. 4e, respectively. These cross-sectional illustrations reveal the internal arrangement of the first body 114, the second body 116, and the hinge region 110 when fully assembled.

As shown in FIGS. 3a-3h and 4a-4j, the hinge clip assembly 102 comprises the first body 114 and the second body 116 that are hingedly coupled to one another via a hinge 112. The hinge 112 permits the first body 114 and the second body 116 to pivot relative to each other as indicated by arrow 206 (FIG. 1c). This pivoting action allows the hinge clip assembly 102 to transition between a shipment position (FIGS. 3a–3h) and an installed position (FIGS. 4a–4j). In some embodiments, the hinge 112 may be configured as a living hinge integrally formed with the first body 114 and the second body 116, thereby reducing part count and increasing durability.

The hinge clip assembly 102 is configured to secure to the hinge region 110 of the lid 106. The hinge region 110 may define a plurality of through-holes 112, which receive fastening elements of the hinge clip assembly 102. Each of the illustrated through-holes 112 is illustrated as generally circular. When assembled, a portion of the lid 106 is sandwiched between the first body 114 and the second body 116, thereby clamping the hinge region 110 securely.

The first body 114 and the second body 116 may be fastened together using a plurality of interlocking snaps 122, which are resiliently coupled to one of the first body 114 and the second body 116. Each of the interlocking snaps 122 includes a barb 202 (e.g., a triangular protrusion, as illustrated) that is configured to engage another barb 202 of a corresponding interlocking snap 122 through an interference fit. As illustrated Detail A (FIG. 2c), the barbs 202 of a pair of interlocking snaps 122 are oriented towards one another to facilitate engagement.

When assuming the installed position, the barbs 202 bias the interlocking snaps 122 away from one other until the barbs 202 clear one another, at which point the interlocking snaps 122 return to the original position. Once in the installed position, the interlocking snaps 122 interfere with one another via the barbs 202 to hold the first body 114 and the second body 116 in the installed position, sandwiching the hinge region 110. To remove the clip assembly 102, the first body 114 and the second body 116 can be pulled away from one another with sufficient force such that the interlocking snaps 122 bias away from one another to allow the barbs 202 to again clear one another.

In one embodiment, the first body 114 includes protruding snap features 122b that engage complementary snap features 122a on the second body 116. Engagement may occur through the through-holes 112 of the hinge region 110, thereby locking the first body 114 and the second body 116 together and preventing relative movement.

As illustrated in FIGS. 3g and 3h, each snap 122 may be configured with a D-shaped cross section (the cross section that is transvers to the length of the snap 122) feature to facilitate alignment and assembly. For example, a snap 122a on the first body 114 may have a semi-circular cross-section, while a corresponding snap 122b on the second body 116 includes an opposing semi-circular portion. When engaged, the snaps 122a and 122b of a given set together define a substantially circular profile corresponding to the through-holes 112. The D-shaped configuration prevents rotational binding during insertion into the through-holes 112 while still providing strong retention once engaged. Alternative embodiments may employ cylindrical snaps, barbed snaps, rivet-like structures, or mechanical fasteners (e.g., screws or pins).

The hinge region 110 of the lid 106 may be recessed and shaped to complement the geometry of the first body 114 and/or second body 116, thereby mitigating lateral movement and ensuring consistent alignment during repeated pivoting of the lid 106. The recess may further provide a flush fit, minimizing interference with adjacent structures of the container 104.

The hinge 112 may, as illustrated, be configured as a living hinge integrally molded with the first and second bodies. The hinge 112 may include a central flat spacer 124a flanked by two flexible portions 124b. The flat spacer 124a may be sized to correspond substantially to the thickness of the hinge region 110 of the lid 106, thereby ensuring a snug fit without excessive compression. The flexible portions 124b may be reduced-thickness webs that allow repeated bending and resilient recovery, enabling the hinge clip assembly 102 to be opened and closed multiple times without material fatigue. In alternative embodiments, the hinge 112 may be a discrete pin joint, a film hinge, or a multi-component hinge with metallic reinforcement.

In use, the hinge clip assembly 102 permits simplified assembly of the lid 106 to the container 104 without the need for separate fasteners or tools. The installer may align the hinge region 110 of the lid 106 with the hinge clip assembly 102, pivot the first and second bodies toward each other about the hinge 112, and snap the bodies together through the through-holes 112. Once installed, the hinge clip 118 receives the pin 128, thereby hingedly coupling the lid 106 to the container 104. The stop 204 prevents over-rotation and helps maintain the lid 106 in a closed position.

The hinge clip assembly 102 may be fabricated as a unitary structure from a wide range of materials and by various manufacturing processes depending on performance requirements. Suitable materials include thermoplastics such as polypropylene, polyethylene, polyamide (nylon), acetal, polycarbonate, acrylonitrile butadiene styrene (ABS), and polyvinyl chloride (PVC); thermoplastic elastomers (TPEs), which may be particularly advantageous for hinge portions such as hinge 112 to enhance flexibility and fatigue resistance; composite materials such as fiberglass; and metals such as die-cast aluminum, stamped steel, or alloys thereof. Multi-material assemblies are also contemplated, for example with a rigid body portion combined with a flexible elastomeric hinge portion. The hinge clip assembly 102 may be produced by injection molding, providing cost-efficient and high-volume fabrication, or by additive manufacturing (e.g., 3D printing of thermoplastic materials), which enables the formation of complex or highly precise features.

Additive manufacturing techniques obviate the need for mold tooling typically associated with plastic injection molding, thereby lowering up-front manufacturing costs, which is particularly advantageous in low-volume productions. In some examples, components of the hinge clip assembly 102 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process.

While the foregoing description has referred to a hinge clip assembly 102 including a hinge clip 118 with a snap-fit pin receiver 120, numerous alternative constructions are possible within the scope of the present disclosure. For example, in some embodiments, the pin receiver 120 may be a closed loop or eyelet that fully surrounds the pin 128, thereby providing additional rotational stability. In other embodiments, the pin receiver 120 may be an open channel that is laterally inserted onto the pin 128, thereby permitting simplified assembly without axial clearance.

The stop 204 may take various forms. In one embodiment, the stop 204 may be a protruding flange integrally molded with the hinge clip 118. In another embodiment, the stop 204 may comprise a separate component that is mounted, bonded, or overmolded onto the hinge clip 118. In still other embodiments, the stop 204 may be omitted entirely, such that the lid 106 is retained in a closed position by frictional interference between the hinge clip 118 and the pin 128 or by a separate latch mechanism provided elsewhere in the system 100.

The hinge 112 has been described as a living hinge, but other hinge types may be employed. For instance, the hinge 112 may be replaced by a mechanical knuckle hinge, a piano hinge, or a metallic pin joint, particularly where higher load-bearing capacity is required. A removable hinge element may also be provided, permitting the first body 114 and the second body 116 to be completely separated for service or replacement.

The snaps 122 may likewise be varied. In certain embodiments, the snaps 122 may be configured with barbed edges to resist disengagement. In other embodiments, the snaps 122 may be metallic rivets, screws, or threaded fasteners extending through the through-holes 112 of the hinge region 110. In still further embodiments, an adhesive layer, ultrasonic welding, or thermal staking may be used in lieu of, or in addition to, mechanical snaps to secure the first and second bodies together.

The geometry of the first body 114 and the second body 116 may be modified to suit different lid geometries. For example, either body may include a recessed channel, ribbing, or reinforcement gussets to increase rigidity. The bodies may be elongated to accommodate wider hinge regions or shortened for compact applications. The exterior surfaces may be shaped with contours to complement surrounding vehicle trim.

Although illustrated in connection with a vehicular storage system 100, the hinge clip assembly 102 may be adapted for numerous other uses. Examples include consumer storage containers, toolboxes, appliance compartments, electronic housings, outdoor enclosures, medical equipment cases, and shipping containers. The scalability of the hinge clip assembly 102 allows it to be employed in both small-scale portable devices and large-scale industrial enclosures.

The hinge clip assembly 102 offers numerous advantages compared to prior hinge and fastening solutions. First, the design permits tool-less installation. The installer may secure the lid 106 to the container 104 simply by aligning the hinge region 110, pivoting the first and second bodies together, and snapping the snaps 122 into place. This reduces assembly time and eliminates the need for specialized tools or fasteners.

Second, the hinge clip assembly 102 provides robust retention. The interlocking snaps 122, when engaged through the through-holes 112, form a secure mechanical connection that resists both axial separation and lateral movement. The D-shaped configuration of the snaps facilitates smooth assembly while ensuring strong locking engagement once fully seated.

Third, the use of a living hinge 112 reduces part count and improves durability. Because the hinge 112 is integrally formed with the first and second bodies, there is no need for additional hinge pins, knuckles, or brackets. The living hinge is capable of repeated cycles of opening and closing without significant wear, thereby extending the service life of the assembly.

Fourth, the hinge clip assembly 102 provides alignment and stability. The recessed hinge region 110 of the lid 106 complements the contour of the first and second bodies, minimizing side-to-side play. This ensures that the lid 106 pivots consistently along the intended axis and resists torsional loads.

Fifth, the hinge clip assembly 102 enables compact packaging. The low-profile construction allows the assembly to fit into shallow cavities and maintain a flush exterior surface, which is particularly advantageous in vehicle interiors where space is constrained.

Sixth, the assembly is versatile. By altering the geometry of the pin receiver 120, the stop 204, or the snaps 122, the hinge clip assembly 102 can be adapted for different lid thicknesses, container wall geometries, and functional requirements.

Finally, the assembly provides cost efficiency. The hinge clip assembly 102 may be manufactured as a single molded component, reducing tooling complexity and material usage. The elimination of discrete fasteners and metal hardware further reduces overall cost and simplifies recycling at end-of-life.

While the present method and/or system have been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A hinge clip assembly for coupling a lid to a container having a pin, comprising:
a first body;
a second body; and
a hinge coupling the first body to the second body, the first body and the second body being pivotable relative to one another between a shipment position and an installed position,
wherein, in the installed position, at least a portion of the lid is sandwiched between the first body and the second body, and
wherein the hinge defines a pin receiver configured to pivotally secure with the pin of the container to permit rotation of the lid relative to the container.

2. The hinge clip assembly of claim 1, wherein the hinge comprises a hinge clip defining the pin receiver.

3. The hinge clip assembly of claim 2, wherein the hinge clip comprises a stop configured to engage the container and thereby limit movement of the lid to a closed position.

4. The hinge clip assembly of claim 1, wherein the hinge comprises a living hinge integrally formed with the first body and the second body.

5. The hinge clip assembly of claim 4, wherein the living hinge includes a flat spacer sized to correspond to a thickness of the lid at a hinge region, and at least one flexible area disposed adjacent the flat spacer.

6. The hinge clip assembly of claim 1, further comprising a plurality of snaps configured to couple the first body to the second body.

7. The hinge clip assembly of claim 6, wherein at least one snap of the first body is configured to engage with a complementary snap of the second body to collectively define a generally circular cross-section.

8. The hinge clip assembly of claim 7, wherein each snap is generally D-shaped in cross-section to facilitate insertion through a corresponding through-hole in the lid.

9. The hinge clip assembly of claim 1, wherein a hinge region of the lid comprises a plurality of through-holes through which the snaps extend to secure the hinge clip assembly to the lid.

10. The hinge clip assembly of claim 1, wherein the hinge region of the lid is recessed and shaped to complement the first body and/or the second body, thereby mitigating lateral movement of the hinge clip assembly relative to the lid.

11. The hinge clip assembly of claim 1, wherein the hinge clip assembly is fabricated from a thermoplastic material.

12. The hinge clip assembly of claim 1, wherein the hinge clip assembly is fabricated from a thermoplastic elastomer (TPE).

13. The hinge clip assembly of claim 1, wherein the hinge clip assembly comprises a composite material.

14. The hinge clip assembly of claim 1, wherein the hinge permits rotation of the lid about an axis defined by the pin, the lid being movable between an open position and a closed position relative to the container.

15. The hinge clip assembly of claim 1, wherein the lid includes a handle, and the hinge clip assembly and the pin collectively support hinged movement of the lid.

16. The hinge clip assembly of claim 1, wherein the hinge clip assembly is a unitary component.

17. A hinge clip assembly for coupling a lid to a container having a pin, comprising:
a first body and a second body;
a living hinge integrally formed with the first body and the second body, the living hinge including a flat spacer sized to correspond to a thickness of a hinge region of the lid and at least one flexible area disposed adjacent the flat spacer; and
a plurality of snaps configured to couple the first body to the second body,
wherein, in an installed position, at least a portion of the lid is sandwiched between the first body and the second body, the plurality of snaps extend through corresponding through-holes in the lid, and the living hinge defines a pin receiver configured to pivotally secure with the pin of the container to permit rotation of the lid relative to the container.

18. The hinge clip assembly of claim 17, wherein at least one snap of the first body engages with a complementary snap of the second body to collectively define a generally circular cross-section.

19. The hinge clip assembly of claim 17, wherein each snap is generally D-shaped in cross-section and includes a chamfered leading edge to facilitate insertion through the corresponding through-hole in the lid.

20. The hinge clip assembly of claim 17, wherein the hinge region of the lid is recessed and shaped to complement the first body and/or the second body, and further comprises alignment ribs configured to engage grooves in the hinge clip assembly to mitigate lateral movement of the hinge clip assembly relative to the lid.
